(19) United States
(12) Patent Application Publication
(10) Pub. No.: US 2005/0058573 A1
(43) Pub. Date: Mar. 17, 2005

(54) Use of rapid prototyping techniques for the rapid production of laboratory or workplace automation processes

(76) Inventor: James Dahle Frost III, The Woodlands, TX (US)

Correspondence Address: Mark A. Oathout, SUITE 960, 3701 KIRBY DRIVE, Houston, TX, 77098, US

(21) Appl. No.: 10/768,475

(22) Filed: Jan. 30, 2004

Related U.S. Application Data
(60) Provisional application No. 60/502,695, filed on Sep. 12, 2003.

(51) Int. Cl. G05D 25/00

(52) U.S. Cl. 422/62

(57) ABSTRACT

A laboratory process may be automated with a rapid prototype machine used to produce devices for use in the laboratory. A computer aided design system in communication with said rapid prototype machine is used to generate data for the rapid prototype machine. The data enables the rapid prototype machine to produce devices, such as, for example, end effecters to be used in a robotic work station in a research lab.

### CROSS-REFERENCE TO RELATED APPLICATIONS

This application claims the benefit of U.S. provisional application number 60/502,695 filed Sep. 12, 2003.

### STATEMENTS REGARDING FEDERALLY SPONSORED RESEARCH OR DEVELOPMENT

Not applicable.

### REFERENCE TO A MICROFICHE APPENDIX

Not applicable.

### BACKGROUND OF THE INVENTION

Description of the Related Art

In the past, tools or end effecters designed for use in a laboratory or a facility a semiconductor production facility), made of metal, or molded plastic, have taken an te amount of time to design, develop, manufacture and implement.

### BRIEF SUMMARY OF THE INVENTION

In the modern workplace or facility (which include laboratories and, for sake of convenience, all of which may be referred to as “laboratory” or “laboratories” herein), a system is needed for the quick design, development and implementation of laboratory automation systems.

A system for automating a laboratory process has a rapid prototype machine used to produce devices for use in the laboratory. A computer aided design system in communication with said rapid prototype machine is used to generate data for the rapid prototype machine. The data enables the rapid prototype machine to produce devices, such as, for example, end effecters to be used in a robotic work station in a research lab.

### BRIEF DESCRIPTION OF THE SEVERAL VIEWS OF THE DRAWINGS

FIG. 1 is a schematic view of one embodiment.

FIG. 2 is a perspective view of one embodiment of an arm for mounting to a robot, the arm being connected to several end effecters.

FIG. 3 is a perspective view of one embodiment of a petri dish or agar plate end effecter.

FIG. 4A is a perspective view of one embodiment of a Petri dish or agar plate stacker.

FIG. 4B is an exploded view of the device shown in FIG. 4A.

FIG. 5 is a perspective view of one embodiment of a reagent delivery end effecter.

FIG. 6 is a perspective view of one embodiment of a vial manipulator arm.

FIG. 7 is a perspective view of one embodiment of a variable span pipette end effecter.

FIG. 8 is a perspective view of one embodiment of a well plate manipulator.

FIG. 9A is a perspective view of one embodiment of a servo pipette end effecter.

FIG. 9B is an exploded view of the device shown in FIG. 9A.

FIG. 10A is a perspective view of one embodiment of a mixing bead dispenser.

FIG. 10B is an exploded view of the device shown in FIG. 10A.

FIG. 11A is a perspective view of a well plate stacker.

FIG. 11B is another view of the device shown in FIG. 11A

### DETAILED DESCRIPION OF THE PREFERRED EMBODIMNET(S)

A rapid prototype machine 20 may be used to produce a variety of devices 40 for use in a laboratory 30 (or any facility or workplace using relatively light payloads, i.e., those which may be handled with a rapid prototyping plastic material). A computer 10 is in communication, for example by communication line 12, with the rapid prototype machine 20.

The computer 10 uses software, which can generate data for input into the rapid prototyping machine 20. The advantages of this system and methodology include faster, less expensive production of devices 40 for use in a laboratory 30.

As mentioned a computer 10 may be used for inputting data into the rapid prototype machine 20. The computer preferably includes three-dimensional modeling software, which can generate files in an STL format. However, data could be input into the rapid prototype machine 20 in some other manner or by some other device; and other file formats could be developed for use in three-dimensional modeling software and for inputting data to the rapid prototype machine 20.

A user builds a drawing of the device or part 40 they desire to build using the three-dimensional modeling software. Some of the options which may be critical in building a part include whether to build the part 40 as sparse (i.e. having a hollow interior) or as a solid; and whether to build the device 40 in standard mode (greater density) or in a draft mode (more jagged). Once the drawing is built, it may be saved as an STL file and input to the machine 20.

The rapid prototype machine 20 is preferably an off-the-shelf machine, which prints plastic layers, one layer at a time, layer upon layer until a device is complete as defined by the data in the relevant STL file. A suitable rapid prototype machine 20 that may be used in the system and methodology is commercially available from Stratasys and sold under the trademark DIMENSION. The DIMENSION printer prints in ABS plastic.

An example, but not exhaustive, list of devices 40 which could be built by Rapid Automation Development System (“RADS”) for use in and supplied to a laboratory include stands, racks, receptacles, dispensers, plate stackers, pipe heading for reagent distribution, tools (including robotics tools), manifolds, gears, cogs, general helix threading, channels (may be built in halves and glued together), biasing means coupled with an actuating force such as air, screw holes in a part, or anything suitable for producing and use at a laboratory workstation. Robotics end-of-arm tools 40a could include, but are not limited to, vacuum grippers, mechanical grippers, magnetic pick-up devices, and single or multi-channel pipet heads for use with, for example, SCARA (Selective Compliant Assembly/Articulated Robot Arm) robots 42 such as a D-TRAN robot made by Seiko.

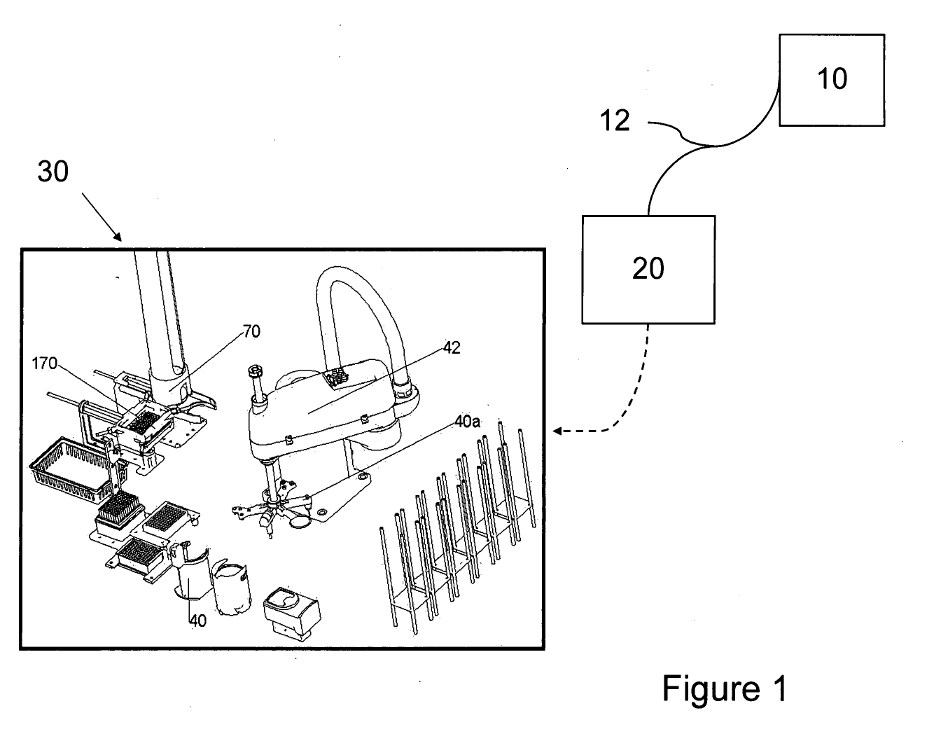

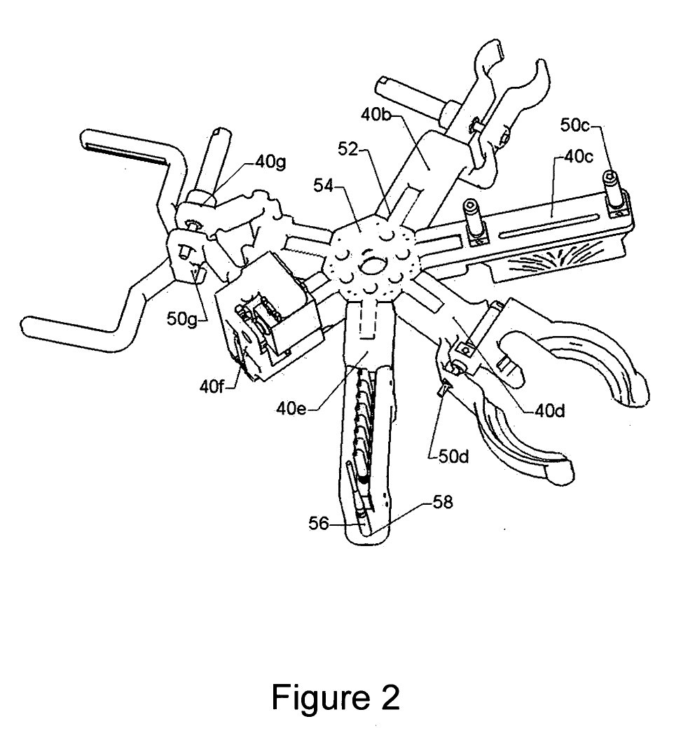

Referring to FIG. 2, the devices 40 or end-of-arm tools (“end effecters”) 40a shown include a vial manipulator arm 40b, a variable span pipette header 40c, a Petri dish manipulator arm 40d, a reagent delivery arm 40e, a servo controlled disposable tip pipetting arm 40f, and a ninety-six well plate handling arm 40g. These devices 40 and end effecters 40a may be used collectively in a laboratory as shown and described with respect to FIG. 1.

Hinges 52 (six are shown) connect each respective device 40 to a hub or robot arm mount 54. The robot arm mount 54 attaches to the robot 42. Each hinge 52 is contoured allowing its respective device 40 to pop up if an obstruction is bumped or encountered (e.g. one end of the device 40 may have a male or concave contour and another end of the hinge 52 may have a female or convex contour). Each of these devices 40 may include an actuator, e.g., 50c, 50d, 50g. The actuating medium could be pneumatic, hydraulic, electric or the like.

It is important to convey that all of the features or items shown in FIG. 2 can be made with the rapid prototyping machine, except for perhaps the ultrasonic non-contact liquid level sensor 56 (although the support walls 58 around the sensor may be made via RADS).

The techniques disclosed may be used to build a variety of mechanisms and instrumentation. Some typical applications are disclosed herein.

For example, more specific examples of some end effecters made in the rapid prototype machine follow. The end effecters can be integrated with robot(s) or may be used separately.

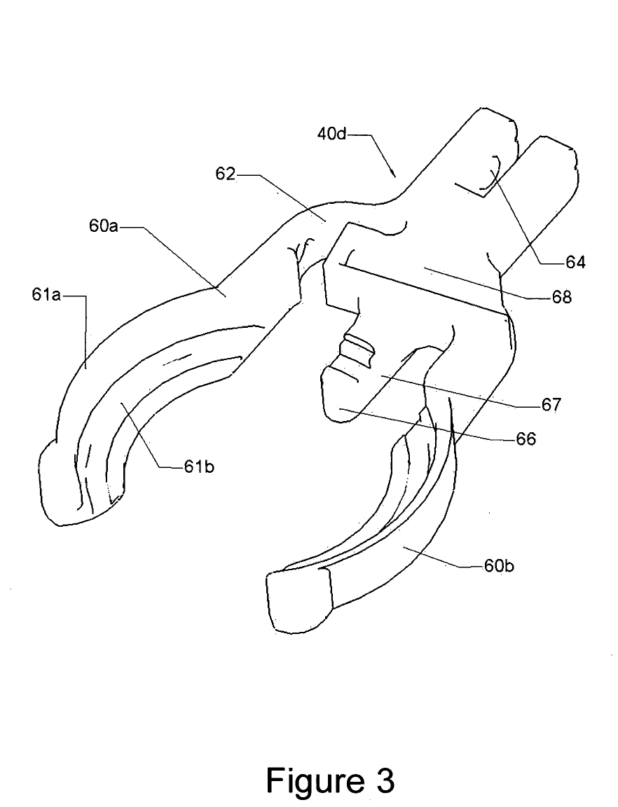

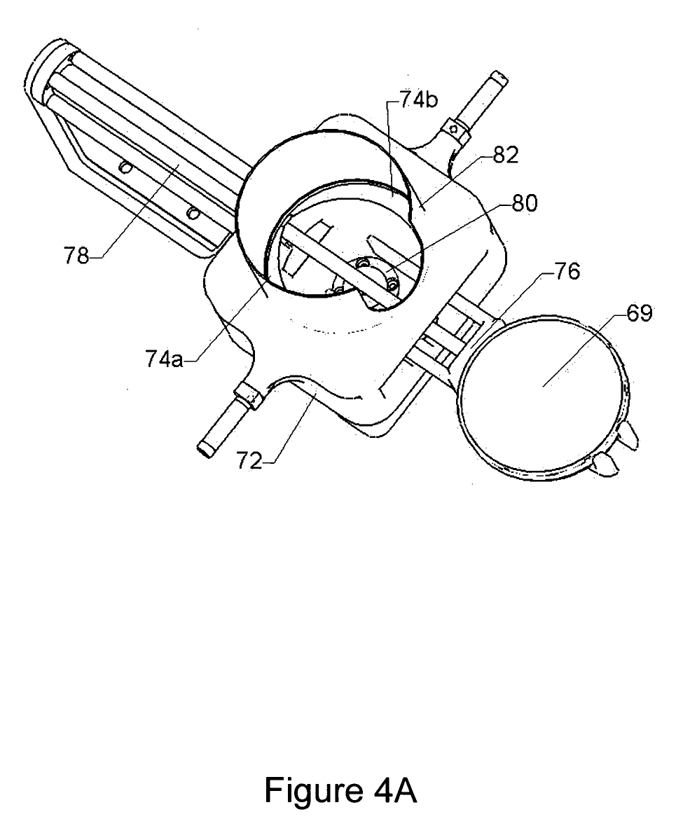

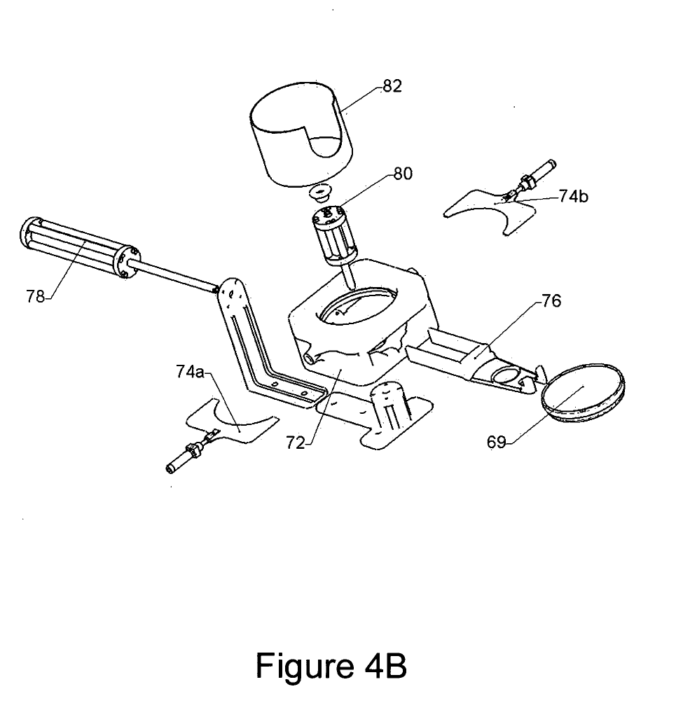

1. Referring to FIG. 3, a Petri dish or agar plate end effecter 40d is shown. The device can be used to manipulate Petri dishes 69 (agar plates or the like). The device 40d has appendages 60a,b with semi-annular ends having a rim portion 61a and shelf portion 61b (allowing a cupping design to conform to the exact shape of the dish as such dishes come in many different sizes, allowing for a firm grip, and self alignment; for the model shown in the drawing, this self alignment feature works with 90-100 mm OD Petri dishes that are between 15-16 mm in height); a hinge design 62 to speed and simplify production, a popup design 64 for connection to a hinge 52 and to reduce breakage; pneumatic lines or passageways 66 built into the device to reduce assembly time and to reduce the possibility of pneumatic lines catching during operation; and a chamber 68 for an air piston (to actuate gripping and shaking of the dishes). This end effecter 40d allows a Petri dish 69 to be removed from the Petri dish stacker 70 (FIGS. 4A and 4B) and can be used to shake plates and remove mixing beads when attached to a SCARA robot; it functions as an air piston gripper for the side gripping of a Petri dish 69 and a vacuum gripper body 67 and passages 66 on the bottom of the end effecter 40d via attaching a suction cup (not shown) allows a Petri dish 69 lid to be removed for the addition of mixing beads (not shown) and liquids or removal of beads.

2. Referring to FIGS. 4A & 4B the Petri (or agar) dish stacker 70 has a stacking body 72, holders 74a & b allowing the introduction of Petri dishes 69 into a partially filled stack, a Petri dish presenter slide 76, a piston 78 for connection to the presenter slide 76, a shaft 80 for pushing a stack of Petri dishes onto the holders 74a & b, and a stack supporting tube 82. The stacker 70 allows presentation of a Petri dish 69 to a robot 42 and allows reloading of finished dishes 69. The Petri (or agar) dish stacker 70 includes four pistons and five RADS-designed parts. Each Petri (or agar) dish stacker 70 holds fifty plates; can present a plate 69 and can put plate back into a stack 70. With three Petri dish stackers 70 one can set up a robot 42 to process a ninety-six well plate unattended. This stacker works for Petri dishes with an outside dimension between 90 mm and 100 mm. It can be customized for what ever size you need. The stacker 70 may be controlled by a microcontroller that accepts ActiveX commands thru a serial connection.

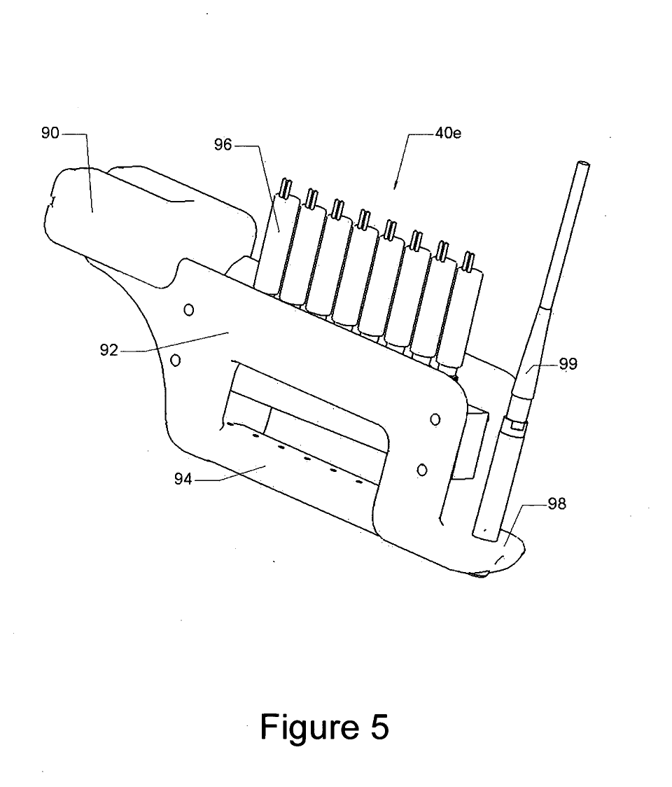

3. Referring to FIG. 5, a reagent delivery end effecter 40e is shown. The reagent delivery end effecter or arm 40e has a popup hinge design 90, sidewalls 92 and a mounting base/manifold 94 all of which may be made with the rapid prototype machine. The mounting base/manifold 94 combines a PEEK reagent manifold with mounting chambers for eight Kloehn 2-way valves for independent reagent addition in a 9 mm spacing relationship into 96. The reagent delivery end effecter 40e is used for reagent delivery into ninety-sixwell plates. A passage 98 is also formed for the mounting of a non-contact ultrasonic liquid level senor 99 (for sensing ninety-sixwell plates to measure distance and volume in each well). This end effector 40e can actually select from up to twelve fluids, deliver fluid(s), maintain fluid(s), and remove fluid(s).

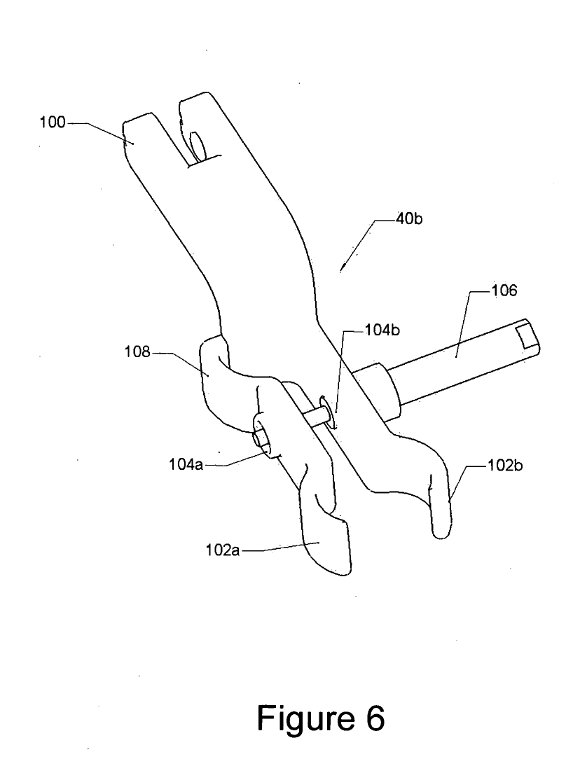

4. Referring to FIG. 6, a vial manipulator end effecter 40b may be made with the rapid prototype machine. This end-effecter 40b has a popup design 100, semi-annular appendages 102a & b, chamber 104a & b for the mounting of an air piston 106, and a built-in hinge structure 108. This design allows the vial manipulator end effecter 40b to pick up and move 50 ml vials using a SCARA robot. A single output can control both the pick and place operation. Adhesive backed rubber or TEFLON may be applied to the semi-annular appendages 102a & b depending upon the application and chemical resistivity required.

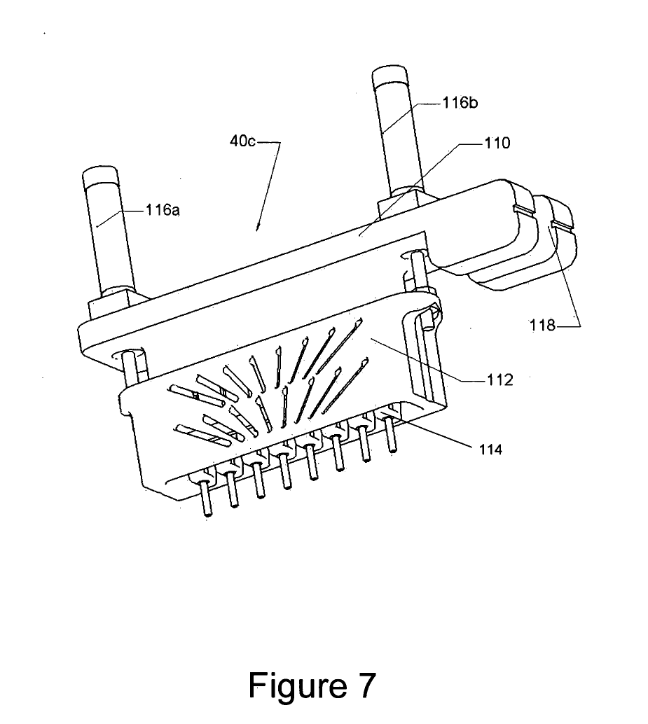

5. Referring to FIG. 7, a variable span pipette head end effecter 40c with manifold 110, adjusting means 112 and tubes 114 may be made with the rapid prototype machine (similar type designs made of metal are known). This end effecter 40c, for example, allows one to pipette or dispense (to a fluid line, test tube or well) from 9 mm spacing and to slide-adjust to pipette or dispense into 4.5 mm spacing. The arm 40c can be connected to syringe pumps, valves or other pumping systems. With the use of this end effecter, one can pipette from, for example, ninety-six-well plates and slide adjust to 384-well plates without interleaving. The arm 40c is operated with two air pistons 116a & b and such mechanism can be customized to any desired spacing. Again, a break resistant hinge design 118 allows arm to pop up in the event of crashing the robot arm down onto an object.

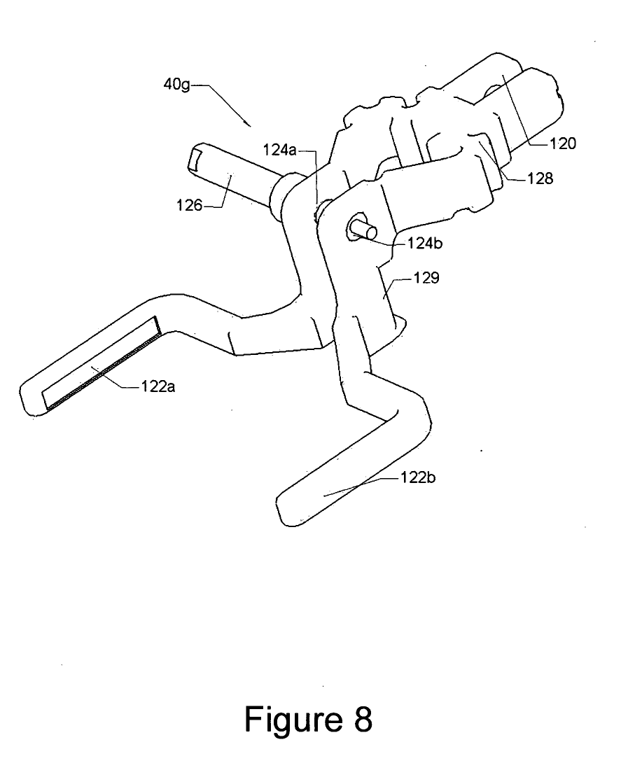

6. Referring to FIG. 8, a well plate manipulator end effecter 40g may be made with the rapid prototype machine. This end-effecter 40g has a popup design 120, right-angle appendages 122a & b, chamber 124a & b for the mounting of an air piston 126, and a built-in hinge structure 128. This design allows the a well plate manipulator end effecter 40g to pick up and move ninety-six well plates using a SCARA robot. A single output can control both the pick and place operation. Adhesive backed rubber or TEFLON may be applied to the right-angle appendages 122a & b depending upon the application and chemical resistivity required. The right-angle appendages 122b has a slot 129 for adding a mechanical or optical switch to verify actuation of an appendage.

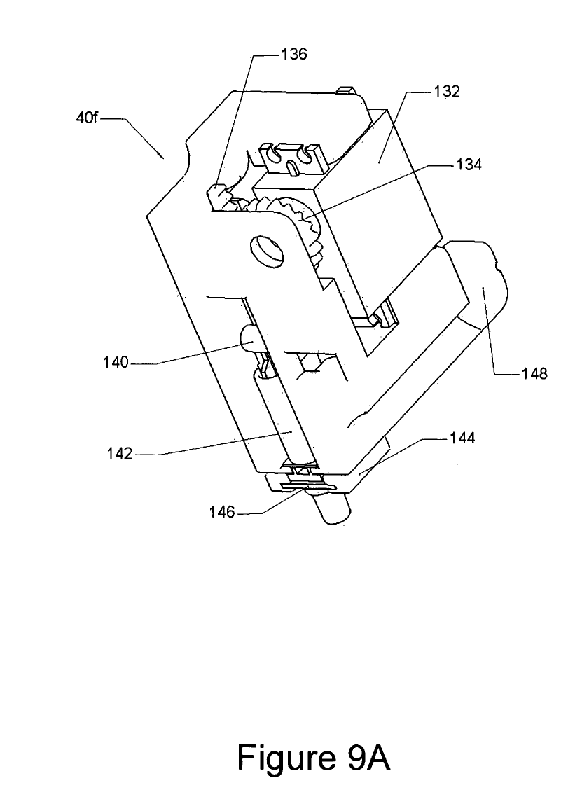

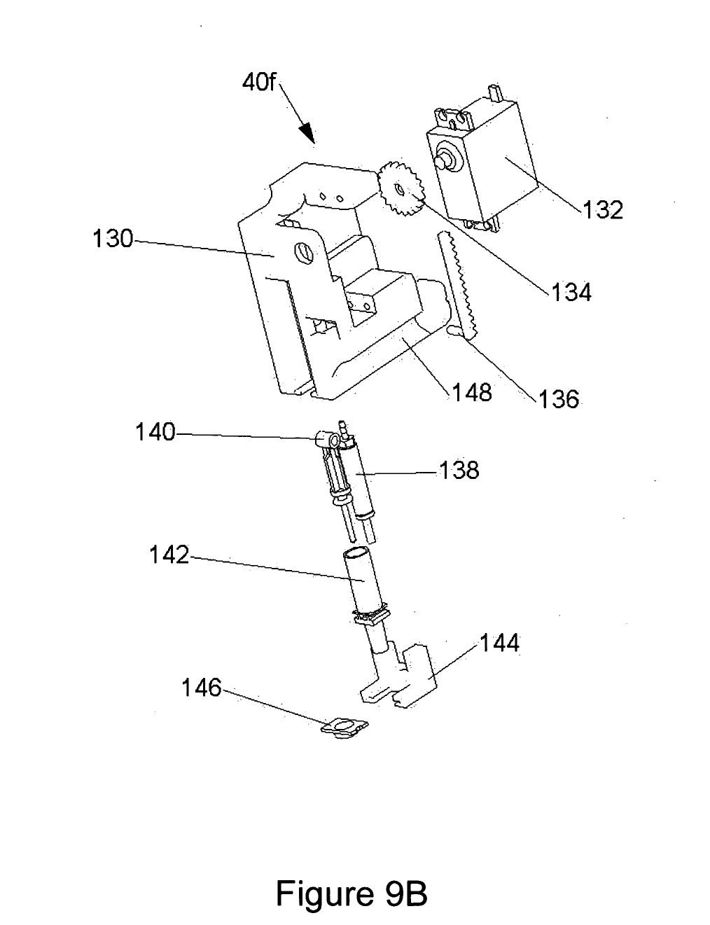

7. Referring to FIGS. 9A & B, a servo pipette end effecter 40f may be made with the rapid prototype machine 20. The servo pipette end effecter 40f has a frame 130, a servo motor 132, a gear adapted for servo 134, a linear syringe drive 136, a piston 138, a pipet syringe plunger 140, a pipet tip holder with syringe barrel 142, a piston to pipet release adapter 144, a pipet tip release 146, and a robot arm connector 148. The design and use of such a device are known in the art.

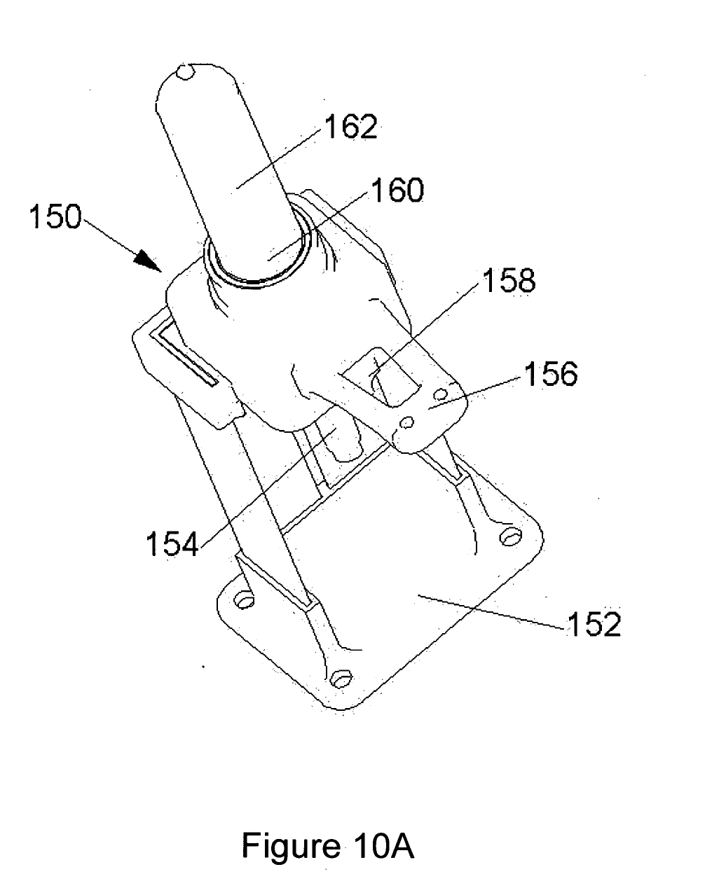

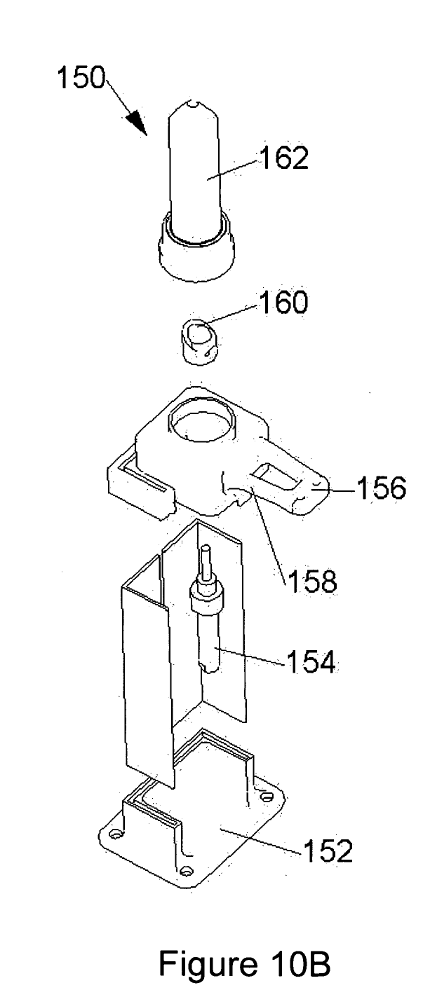

8. Referring to FIGS. 10A & B, a mixing bead dispenser 150 is shown and most of its parts may be made with the rapid prototype machine 20. The mixing bead dispenser generally has a base 152, a piston 154 for bead separation, a Petri dish lid remover 156 (similar to as discussed with respect to FIG. 3 above), a mounting chamber 158 for an infrared sensor for bead counting, a bead separator 160, and a 50 ml plastic vial 162 for containing beads (not shown) which may be used in a lab.

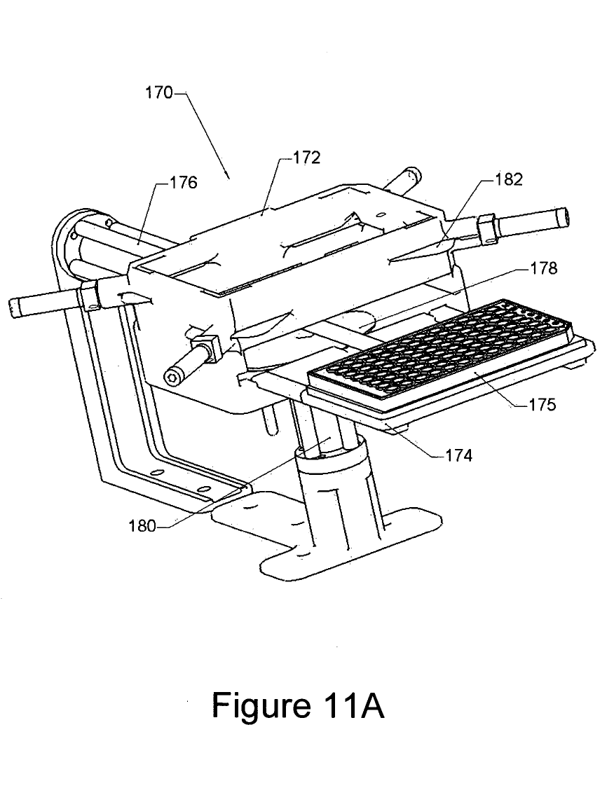

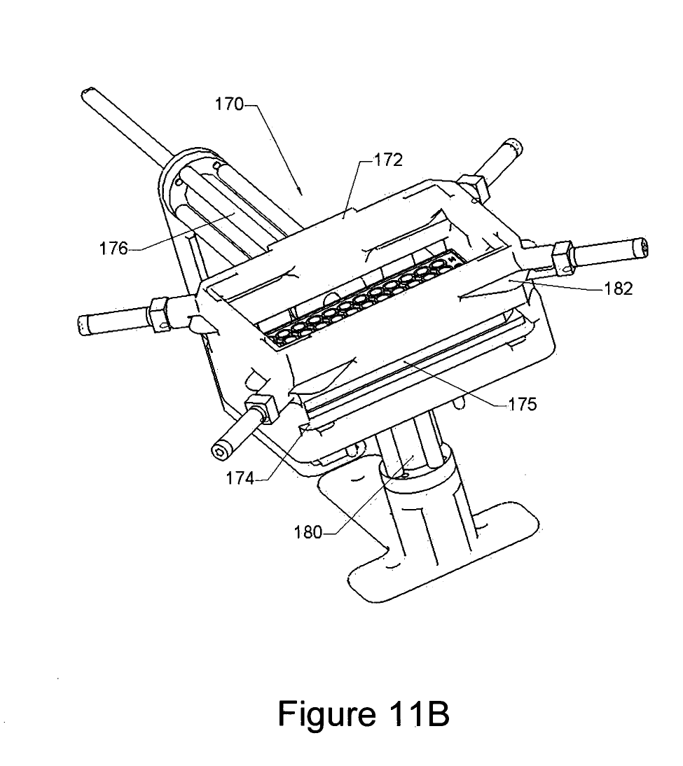

9. Referring to FIGS. 11A & B, a ninety-sixwell plate stacker 170 is shown and most of its parts may be made with the rapid prototype machine 20. The ninety-six well plate stacker 170 generally has a frame 172, a well plate presentation slide 174 (shown holding a ninety-six well plate 175), a piston 176 used to present a ninety-six well plate 175 to the robot 42, a lower stack holder 178 for dispensing a single plate 175 from the stack, a second piston 180 used to push a stack of ninety-six well plates up onto the lower stack holder 178, and four upper stack holders 182 for holding the stack of ninety-six well plates 175 while the lower stack holder 178 releases a single plate.

In the above examples, types of items which may not lend themselves to manufacture via a rapid prototype machine or process include actuators, servo motors, pistons, sensors, hose barbs, hoses, and vacuum grippers.

In another example, the system and methodology can be used in the production of devices 40 for use in a laboratory for a gene synthesis process.

Liners and/or sleeves (not shown) could be made for the laboratory devices 40 in the event that plastic or ABS plastic is not compatible with a specific laboratory requirement or environment.

The above examples are just some current examples of devices which may be made. There are many more possibilities. The needs of each laboratory 30, the creativity of those working for the lab 30, the material, the resolution which is required in the end effecter will dictate the devices 40 (or kits of devices) which may be designed and produced with the aforementioned system and methodology.

Certain variations may be made to the preferred embodiment as would be known to one of ordinary skill in the art without departing from the spirit of the invention.

1. A method for using a rapid prototype machine, which includes the step of producing at least one device from the rapid prototype machine, comprising:
using the device in a laboratory in a non-prototype application.

2. The method according to claim 1, further comprising the step of:
designing the device prior to said step of producing the device, wherein said designing step includes determining a strength of a material requirement for the device.

3. The method according to claim 1, further comprising the steps of:
connecting the device to a robot; and
using the robot in the laboratory.

4. The method according to claim 3, further comprising the steps of:
using the device as an end effecter in the laboratory.

5. The method according to claim 4, wherein said step of using the device comprises a step for effecting a laboratory process selected from the group of steps consisting of gripping, holding, spanning a first well plate having a different size from a second well plate, stacking, filling, dispensing, manipulating, and distributing a fluid.

6. The method according to claim 3, wherein said connecting step includes hinging the device to the robot.

7. The method according to claim 1, wherein said step of using the device in the laboratory in a non-prototype application comprises using the device in a working laboratory.

8. A method for producing at least one end effecter for a robot to be used in a laboratory, comprising the steps of:
submitting data to a rapid prototype machine; and
using the rapid prototype machine to produce the end effecter.

9. The method according to claim 8, further including the step of:
designing the end effecter prior to said step of submitting data, wherein said designing step includes determining a strength of a material requirement for the end effecter.

10. A system for automating a laboratory process, comprising:
a robot;
a rapid prototyped device connected to the robot.

11. The system according to claim 10, further including a rapid prototype machine used to produce said rapid prototyped device.

12. The system according to claim 11, further including a computer aided design system in communication with said rapid prototype machine.

13. The system according to claim 11, wherein said rapid prototyped device is one or more devices selected from a group of devices consisting of a gripper, a holder, a spanner for a first well plate having a different size from a second well plate, a stacker, a liquid filling device, a dispenser, a manipulating device, and a fluid distributor.

14. A system for automating a laboratory process, comprising:
a rapid prototype machine used to produce a non-prototype device; and
a computer aided design system in communication with said rapid prototype machine.

15. An end effecter used in a working laboratory, comprising:
a first rapid prototyped piece;
a second rapid prototyped piece connected to said first rapid prototyped piece.

16. The apparatus according to claim 15, further including an actuator connected to said first rapid prototyped piece.

17. The apparatus according to claim 15, further including a rapid prototyped hinge connected to said first rapid prototyped piece.

18. The apparatus according to claim 15, wherein said first rapid prototyped piece is a first portion of a channel; and
wherein said second rapid prototyped piece is a second portion of the channel to be joined to said first portion.

19. The apparatus according to claim 15, further including a non-rapid prototyped piece connected to said first rapid prototyped piece.

20. The apparatus according to claim 15, further including a rapid prototyped robot arm connectable to said first rapid prototyped piece and to said second rapid prototyped piece.
